(19) United States
(12) Patent Application Publication
(10) Pub. No.: US 2023/0375047 A1
(43) Pub. Date: Nov. 23, 2023

(54) COUPLING

(71) Applicant: RENOLD PLC, Wythenshawe, Manchester (GB)

(72) Inventor: Paul Richards, Wythenshawe, Manchester (GB)

(73) Assignee: RENOLD PLC, Wythenshawe, Manchester (GB)

(21) Appl. No.: 18/247,193

(22) PCT Filed: Sep. 30, 2021
(86) PCT No.: PCT/GB2021/052534

§ 371 Date: Mar. 29, 2023

(30) Foreign Application Priority Data
Sep. 30, 2020 (GB) 2015458.9

(51) Int. Cl. F16D 3/68; F16F 15/124

(52) U.S. Cl. CPC F16D 3/68; F16F 15/1245

(57) ABSTRACT

A coupling (2) is disclosed. The coupling (2) comprises an outer member (4), an inner member (8), an intermediate member (6) and a plurality of buffer elements (18, 20). The outer member (4) comprises a plurality of radially inward projections (10), the inner member (6) comprises a plurality of radially outward projections (16) and the intermediate member (6) comprises a plurality of radially inward projections (14) and a plurality of radially outward projections (12). The plurality of buffer elements (18, 20) are disposed between the projections (10, 12, 14, 16). The plurality of radially inward projections (10) of the outer member (4) and the plurality of radially outward projections (12) of the intermediate member (6) are radially overlapped, and the plurality of radially outward projections (16) of the inner member (6) and the plurality of radially inner projections (14) of the intermediate member (6) are radially overlapped.

### FIELD OF INVENTION

The present invention relates to a coupling. The present invention also relates to a marine vessel and to a generator.

### BACKGROUND

Couplings are used to connect rotary shafts such that the torque and rotational speed is transferred from one shaft to another. Shafts exhibit torsional vibration, which is due to multiple factors including the torque being provided to the shaft discontinuously.

Torsional vibration of a shaft is undesirable because it can damage the components to which the shaft is directly or indirectly connected. Torsional vibration of a shaft can be at least partially absorbed using a flexible coupling.

It is an object of the present invention to provide a coupling that at least partially addresses one, or more problems associated with existing systems whether identified herein or otherwise.

### SUMMARY

According to a first aspect of the present invention, there is provided a coupling comprising:
an outer member, an inner member, an intermediate member, and a plurality of buffer elements;
wherein the outer member comprises a plurality of radially inward projections, the inner member comprises a plurality of radially outward projections and the intermediate member comprises a plurality of radially inward projections and a plurality of radially outward projections;
wherein the plurality of buffer elements are disposed between the projections; and
wherein the plurality of radially inward projections of the outer member and the plurality of radially outward projections of the intermediate member are radially overlapped, and the plurality of radially outward projections of the inner member and the plurality of radially inner projections of the intermediate member are radially overlapped.

The coupling according to the present invention includes overlapping radial projections on the outer member, the inner member and the intermediate member. In this way, even if the buffer elements become damaged or are otherwise removed from between the members, the coupling is still able to transmit torque. As such, the coupling may be a fail-safe coupling.

The coupling may be an elastic coupling. The coupling may be a flexible coupling. The coupling may be a compression coupling. As such, the coupling is able to withstand torsional vibration.

The outer member may be a radially outer member. The inner member may be a radially inner member. By radially outer or radially inner, it is understood that such terms refer to the relative radial position of the members. As such, the inner, outer, and intermediate members may be concentric. The inner, outer, and intermediate members are preferably rings. As such, reference to a member is equally reference to a ring. The rings are preferably substantially circular with radial projections from an outer and/or inner circumference of the ring. Whilst the rings may be shapes other than circular, circular rings/members are preferred due to the rotational symmetry.

The intermediate member may be located radially between the radially inner member and the radially outer member. The radially inner member may define an annular body. The radially outer member may define an annular body. The intermediate member may define an annular body. The projections may protrude from their respective annular body.

The radially inner member, the radially outer member and the intermediate member may be concentric. The radially inner member, the radially outer member and the intermediate member may rotate about a common axis of rotation.

The radially outer member may include at least two radially inward projections. The radially inner member may include at least two radially outward projections. The intermediate member may comprise at least two radially inward projections. The intermediate member may comprise at least two radially outward projections. The radially outer member may include at least ten radially inward projections. The radially inner member may include at least ten radially outward projections. The intermediate member may comprise at least ten radially inward and/or outward projections. It will be appreciated that any number of projections may be used and that the exact number of projections used will be selected on the size and performance requirements of the coupling.

The outside diameter of the coupling can be at least 600 mm. The outside diameter of the coupling can be less than or equal to 2500 mm. The outside diameter of the coupling can be between 1000 mm and 2500 mm. Again, it will be appreciated that the outer diameter of the coupling may be any suitable size and may be selected depending on operational requirements.

The coupling may be configured to transfer a torque of at least 10 kNm. The coupling may be configured to transfer a torque of at least 30 kNm.

The number of radially outward projections of the intermediate member may be equal to the number of radially inward projections of the outer member. Each of the radially outward projections of the intermediate member may therefore be disposed between two radially inward projections of the outer member. Preferably, the projections of each member are evenly spaced.

The number of radially inward projections of the intermediate member may be equal to the number of radially outward projections of the inner member. Each of the radially inward projections of the intermediate member may therefore be disposed between two radially outward projections of the inner member. Preferably, the projections of each member are evenly spaced.

The number of radially outward projections of the intermediate member may be different to the number of radially inward projections of the intermediate member. As such, the number of radially inward projections of the outer member may be different to the number of radially outward projections of the inner member. Preferably, the number of radially inward projections on the intermediate member is the same as the number of radially outward projections on the inner member. Similarly, preferably, the number of radially outward projections on the inner member is the same as the number of radially inward projections on the outer member. By having different numbers of projections on the inner and outer members, a different number of spaces between the outer member and the intermediate member and between the intermediate member and the inner member for receiving the buffer elements is formed. For example, where there is a greater number of radially outward projections on the inner member and a corresponding number of radially inward projections on the intermediate member than radially outward projections on the intermediate member and a corresponding number of radially inward projections on the outer member, a greater number of spaces for receiving buffer elements is provided. In this way, the stiffness of the coupling can be adjusted. As such, in one embodiment, there is a greater number of inner buffer elements than outer buffer elements.

Preferably, the number of radially inward projections of the intermediate member may be greater than the number of radially outward projections of the intermediate member. Whilst the reverse configuration is possible, it is generally preferred to have a greater number of radially inward projections in order to form a greater number of spaces to receive buffer elements. This allows a greater number of inner buffer elements to be provided. Since the inner buffer elements are exposed to the highest forces, by providing a greater number of individual buffer elements, the rotational forces can be distributed over more buffer elements such that each individual buffer element bears a smaller load than would otherwise be the case.

The radially inward projections of the intermediate member may interdigitate with the radially outward projections of the radially inner member. The radially outward projections of the intermediate member may interdigitate with the radially inward projections of the radially outer member. The interdigitation of the radially extending projections creates spaces between the projections on adjacent members into which buffer elements may be received.

The coupling may be configured to transfer a torque from a first shaft to a second shaft. The coupling may be configured to transfer a torque from a first flanged component to a second flanged component. The coupling may be configured to transfer a torque from a shaft to a flywheel. Where the coupling is configured to transfer a torque from a first shaft to a second shaft, the first shaft may be connected to the inner member and the second shaft may be connected to the outer member. The inner member may comprise connection points that are configured to receive fasteners. The outer member may comprise connection points that are configured to receive fasteners. The connection points of the inner member and the outer member can allow a respective shaft to be connected to the respective one of the inner member and the outer member. Where the flexible coupling is configured to transfer a torque from a first shaft to a second shaft, the first shaft may be connected to the outer member and the second shaft may be connected to the inner member.

The projections may radially overlap by at least 80% of the radial length of the overlapped projections. The projections may radially overlap by at least 90% of the radial length of the overlapping projections. This amount of radial overlap advantageously allows the buffer elements to be sufficiently engaged by the projections to prevent the buffer elements from being subjected to high deformation resulting from high contact stress between the projections and the buffer elements. It will be appreciated that the overlap of the projections of the inner, outer and intermediate members creates spaces into which the buffer elements may be received. By having a large radial overlap of the members, the buffer elements are limited to the extent to which they can be deformed and also the forces being transferred through the buffer elements are spread across a larger area of the buffer elements than would be the case if the protrusions were shorter. In addition, this amount of radial overlap also allows for some degree of radial misalignment. The radial length of the projections may be measured from a respective surface from which the projections project to the tip of the projection.

It will be appreciated that the radially outer member is not necessarily the radially outermost member, and that the coupling may comprise further members that are located radially outwards of the radially outer member. Each of the radially outer members may include a plurality of radially inward projections that are radially overlapped with radially outward projections of the radially adjacent member. In this way, there may be more than three members.

One or more of the radial members may be metallic. Suitable metals include cast iron, steel or aluminium. The radial members can be non-metallic. Suitable non-metallic materials include plastics, carbon fibre, glass-reinforced plastic or any fibre-impregnated material. In lower torque variants, one or more of the radial members may be plastic. It will be appreciated that the material of the outer member, the intermediate member and the inner member can be different from one another.

As mentioned, the buffer elements associated with each of the radially outward projections of the intermediate member may be disposed between two radially inward projections of the outer member. Preferably, the projections of each member are evenly spaced. The plurality of buffer elements may have a Shore A hardness of at least 45. The buffer elements of the plurality of buffer elements may have a Shore A hardness of at least 90. The coupling may comprise buffer elements all of the same Shore A hardness or may comprise buffer elements having different Shore A hardnesses. The inner buffer elements may be harder than the outer buffer elements. Alternatively, the outer buffer elements may be harder than the inner buffer elements.

Since the coupling comprises a plurality of buffer elements disposed between the projections of the radial members, the coupling comprises two torque transfer zones. A first torque transfer zone is defined by the radially outward projections of the inner member and the radially inward projections of the intermediate member, and a second torque transfer zone is defined by the radially inward projections of the outer member and the radially outward projections of the intermediate member. Providing two torque transfer zones advantageously reduces the stiffness of the coupling, while reducing the volume and mass of the coupling compared to providing multiple couplings. Couplings that include buffer elements are typically rated at a given rotational stiffness. Rotational stiffness may be defined as the angle that the coupling turns through when a given load is applied. If a single coupling cannot provide the required stiffness to connect two shafts, multiple couplings can be connected that are axially adjacent to one another. This configuration can be referred to as the couplings being in series. This method is not only arduous, due to the additional labour required to fit a second coupling, but also occupies additional volume and is heavier than a single coupling. Since the radial members of the present invention are radially adjacent, only a single coupling needs to be connected between the shafts that the coupling is connecting. In addition, the coupling is of reduced weight and volume compared to providing multiple couplings in series. The configuration of the coupling of the present aspect can be referred to as the couplings being in parallel.

The compound rotational stiffness may be the resultant rotational stiffness of the combination of the two torque transfer zones.

Since the coupling comprises an inner member, an intermediate member and an outer member, the coupling is able to account for tolerances in the axial and/or radial misalignment of the shafts to which the coupling is connected. This is because the members of the coupling are able to move at least partially independent of one another. Therefore, since three members are provided an additional degree of freedom is provided compared to a coupling that comprises two members.

Since the plurality of radially inward projections of the radially outer member and the plurality of radially outward projections of the intermediate member are radially overlapped, and the plurality of radially outward projections of the radially inner member and the plurality of radially inner projections of the intermediate member are radially overlapped, the coupling is advantageously fail safe. During normal use, a torque is applied to one of the inner member and the outer member. The torque is then transferred to the other one of the inner member and the outer member via the buffer elements and the projections of the intermediate member. In the event that the buffer elements perish, due to, for example, being subject to excessive heat, the torque can no longer be effectively transferred via the buffer elements. Since the projections are radially overlapped, the projections can directly engage one another in the event that the buffer elements perish, allowing the torque to be transferred between the inner member and the outer member via the intermediate member, even in cases where the buffer elements are damaged or even no longer present. Whilst this may result in additional wear to the coupling, it will still be able to transfer torque until such a time as the buffer elements may be repaired or replaced. This may be particularly advantageous in critical systems as it remains possible to transfer torque despite failure of the buffer elements.

The projections (of any member) may define a first radial surface and a second opposing radial surface. The first radial surface and the second radial surface may extend substantially only in the radial direction. As such, the first and second radial surfaces may be normal or substantially normal to the main body of the member.

The projections may extend only in the radial direction. In other words, the projections may radiate in a direction outwardly from or inwardly to a central point of the members, albeit it being understood that this does not require the projections to physically extend to the central point. The projections may include a base portion that is located at the base of a respective radial surface. The base portion may be provided with a radius or fillet. The base portion may be provided with a chamfer. The radial surfaces of the projections may define at least 25% of the radial length of the projections. The radial surfaces of the projections may define at least 50% of the radial length of the projections. The projections may extend substantially normal to the members. The projections may have substantially linear opposing radial surfaces. The projections may be connected to the respective member by a radiused curve. The shape of the buffer elements may be complimentary to the shape of the respective radiused curve.

Since the projections define a first radial surface and a second radial surface, the torque transfer between the radially outward projections of the inner member and the radially inward projections of the intermediate projection, and between the radially outward projections of the intermediate member and the radially inward projections of the outer member, is substantially in the circumferential direction. In other words, the torque transfer is in the direction of rotation of the flexible coupling. The torque is transferred tangentially or perpendicular to the direction of the protrusions. This advantageously reduces the shear stress that the buffer elements are subjected to in use. This is because transferring the torque between corresponding projections in the circumferential direction applies a load to the buffer elements in a single direction, i.e., the circumferential direction. This reduces or eliminates the shear stress that the projections and the buffer elements are subjected to in use. The shear strength of a component is typically lower than the tensile strength of the component. Therefore, a component is more likely to fail due to a shear load than due to a tensile or compressive load. One of the limiting factors on the torque transfer capacity of the coupling is the stress that the buffer elements are subjected to during use. Therefore, by reducing or eliminating the shear stress that the buffer elements are subjected to, the torque transfer capacity of the coupling is increased compared to a coupling that applies a load that includes both circumferential and radial components.

In other words, if the protrusions did not comprise radial surfaces, the torque would be transferred in a direction having a greater radial component than observed in the present invention, which transfers torque in a substantially circumferential direction. Instead, the buffer elements of the present invention are subject to a compression loading in use.

Compression loading also results in the magnitude of the area of contact between the projections and the buffer elements being greater, therefore distributing the load over a greater area and therefore distributing the resulting stress over a greater area. Providing a more even stress distribution reduces the peak stress that the projections and the buffer elements are subjected to for a given torque. Therefore, greater torques can be applied to the flexible coupling compared to flexible couplings that do not include radial surfaces to transfer torque. In addition, transmitting torque between adjacent elements substantially circumferentially increases the efficiency of the coupling. As such, the coupling is configured to transfer torque in a substantially circumferential direction, preferably with little or no radial component.

As mentioned, the number of radially outward projections of the intermediate member can differ from the number of radially inward projections of the intermediate member. The number of radially outward projections of the inner member can be greater than the number of radially inward projections of the outer member.

The load (or force) that the radially outward projections of the inner member is subject to in use may be greater than the load (or force) that the radially inward projections of the outer member is subject to in use. This is because the load (or force) that the radially inner member and the radially outer member is subject to in use is inversely proportional to the radial distance from the centre point of the inner member and the outer member. Since the number of radially outward projections of the inner member may be greater than the number of radially inward projections of the outer member in some configurations, the load (or force), and therefore stress, that the projections of the inner member, and therefore the buffer elements, are subject to for a given torque applied to the coupling is reduced. If the buffer elements between the inner member and the intermediate member were paired with the buffer elements between the intermediate member and the outer member in a 1:1 relationship, the inner buffer elements would individually be subject to increased loading compared to the outer buffer elements. The present invention allows the forces acting upon the inner and outer buffer elements, namely the buffer elements between the inner member and the intermediate member, and the buffer elements between the intermediate member and the outer member respectively, to be balanced such that one set of buffer elements is not overloaded. It also allows for a greater adjustment of the stiffness of the coupling, and allows the coupling to be less stiff than in existing couplings.

The plurality of buffer elements may comprise a first plurality of buffer elements, the first plurality of buffer elements being located between the plurality of radially inward projections of the outer member and the radially outward projections of the intermediate member.

The first plurality of buffer elements may be a radially outer plurality of buffer elements. The buffer elements of the first plurality of buffer elements may be resilient elements. The first plurality of buffer elements may be made of rubber, which may be natural or man-made rubber. The first plurality of buffer elements may be made of any material with suitable damping properties. The first plurality of buffer elements may be made of a man-made material. The first plurality of buffer elements may be located circumferentially between the plurality of radially inward projections of the outer member and the outward projections of the intermediate member.

The first plurality of buffer elements may comprise a first set of buffer elements and a second set of buffer elements. Where the first plurality of buffer elements comprises a first set of buffer elements and a second set of buffer elements, the first set of buffer elements can be located axially adjacent to the second set of buffer elements.

An axially central portion of the buffer elements of the first plurality of buffer elements can be waisted. “Waisted” may refer to a region of reduced cross-sectional area.

The plurality of buffer elements may comprise a second plurality of buffer elements, the second plurality of buffer elements being located between the radially outward projections of the inner member and the inner projections of the intermediate member.

The second plurality of buffer elements may be referred to as a radially inner plurality of buffer elements. The buffer elements of the second plurality of buffer elements may be resilient elements. The second plurality of buffer elements may be made of rubber, which may be natural or man-made rubber. The second plurality of buffer elements may be made of any material with suitable damping properties. The second plurality of buffer elements may be made of a man-made material. The second plurality of buffer elements may be located circumferentially between the plurality of outward projections of the inner member and the inner projections of the intermediate member.

The second plurality of buffer elements can comprise a first set of buffer elements and a second set of buffer elements. Where the second plurality of buffer elements comprises a first set of buffer elements and a second set of buffer elements, the first set of buffer elements can be located axially adjacent to the second set of buffer elements.

The first plurality of buffer elements may be less stiff than the second plurality of buffer elements.

Since the first plurality of buffer elements can be less stiff than the second plurality of buffer elements, the magnitude of the stress that the buffer elements of the first plurality of buffer elements are subjected to in use is substantially the same as the magnitude of the stress that the buffer elements of the second plurality of buffer elements are subjected to in use. The torque capacity of the coupling is limited by the magnitude stress that the buffer elements are subject to in use. The magnitude of the stress that the buffer elements are subject to in use is a function of the torque that is transferred via the buffer elements and of the stiffness of the buffer elements. In particular, an increase in torque increases the stress that the buffer elements are subject to in use, and an increase in stiffness decreases the stress that the buffer elements are subject to in use. The second plurality of buffer elements transfer torque of a greater magnitude than that of the first plurality of buffer elements. Therefore, buffer elements of the second plurality of buffer elements being stiffer than the buffer elements of the first plurality of buffer elements allows the stress that the second plurality of buffer elements are subject to be substantially the same as that of the first plurality of buffer elements. It will be appreciated that other factors, such as the size and/or shape of the buffer elements, the size and/or shape of the cavities or spaces that are defined by the protrusions of adjacent members and receive the buffer elements and/or the number of buffer elements, among other things, can also affect the magnitude of the stress that the buffer elements are subject to in use.

In other embodiments, the first plurality of buffer elements is stiffer than the second plurality of buffer elements. In either case, it may be each individual buffer element which is stiffer or less stiff, or it may be the entire plurality of one set of buffer elements which is stiffer or less stiff than the entire plurality of the other set of buffer elements.

The size, shape or material of one plurality of buffer elements may differ from that of the other plurality of buffer elements. In some embodiments, the shape of the buffer elements of the first plurality of buffer elements may be substantially identical to the shape of the buffer elements of the second plurality of buffer elements. In some embodiments, the size of the buffer elements of the first plurality of buffer elements may be substantially identical to the size of the buffer elements of the second plurality of buffer elements. In some embodiments, the material that the buffer elements of the first plurality of buffer elements are made of may be different to the material that the buffer elements of the second plurality of buffer elements. In embodiments, the size, shape, materials, and/or hardness of the pluralities of buffer elements may be substantially identical.

In the present invention, it is possible to change the shape and/or number of buffer elements in the inner plurality of buffer elements compared to the shape and/or number of buffer elements in the outer plurality of buffer elements to allow there to be substantially the same stresses on the inner and outer pluralities of buffer elements.

An axially central portion of the buffer elements of the first and/or second plurality of buffer elements can be waisted.

The thickness of the buffer elements of the first and/or second plurality of buffer elements may taper in the radially inward direction.

The first and/or second plurality of buffer elements may be a discorectangular shape in radial cross-section. The first and/or second plurality of buffer elements may be a tapered discorectangular shape in radial cross-section. The first and/or second plurality of buffer elements can be circular in radial cross-section.

The buffer elements of the first plurality of buffer elements, i.e. the outer buffer elements, may be a circular cross-section. The outer buffer elements may be cylindrical in shape.

The buffer elements of the second plurality of buffer elements, i.e. the inner buffer elements may have a tapered discorectangular cross-section. By discorectangular, it is understood that this shape is constructed from a rectangle (or square) with rounded, but not necessarily semi-circular, portions at a pair of opposite sides. In a tapered discorectangular shape, the non-rounded sides of the shape are not parallel, but instead are closer together at one end than the other.

Since the thickness of the buffer elements of the second plurality of buffer elements may taper in the radially inward direction, the load that the projections exert on the buffer elements is more evenly distributed. It will be appreciated that since the protrusions which protrude from the inner member may do so in a direction substantially normal to the surface of the ring portion of the inner member, the distance between the base of adjacent protrusions is less than the distance between the radially outer end of the protrusions. The second plurality of buffer elements being tapered allows the shape of the buffer elements to generally correspond with the shape of the projections. Therefore, the magnitude of the area of engagement between the projections and the second plurality of buffer elements is maximised. Of course, it will be appreciated that the projections may be shaped to include additional features, such as further protrusions or extensions or otherwise be shaped, to retain corresponding buffer elements in position.

The buffer elements of the first plurality of buffer elements may be circular in radial cross-section.

The buffer elements of the first plurality of buffer elements may be cylindrical. Since the torque which acts upon the first plurality of buffer elements can be less than that acting upon the second plurality of buffer elements, the buffer elements of the first plurality of buffer elements may differ in shape to the buffer elements of the second plurality of buffer elements. In other embodiments, they may be the same shape.

A buffer element that is circular in radial cross-section exhibits a greater amount of deformation when subjected to a given load compared to, for example, a buffer element that more completely fills the space between adjacent members and the projections of the adjacent members. This is because where the projections are generally linear, the space between adjacent projections is substantially square or rectangular, albeit the radial outer portion is generally slightly larger since neighbouring projections on the members are not parallel and diverge away from the centre. Therefore, the buffer elements of the first plurality of buffer elements are able to be deformed to a greater degree under a given load, and so the stiffness of the buffer elements is decreased by virtue of the shape of the buffer elements.

The buffer elements are able to fill void space in the cavities or spaces that are defined by the protrusions on adjacent members in which the buffer elements are received at lower loads compared to buffer elements that are of a shape which fills such spaces to a greater degree. This increases the contact area between the projections and the buffer elements of the first plurality of buffer elements at lower loads. This is beneficial because the load that is exerted by the projections on the buffer elements is distributed over a greater area.

The volume of the first plurality of buffer elements may be less than the volume of the second plurality of buffer elements.

The second plurality of buffer elements, i.e. the inner buffer elements may fill a greater proportion of the volume of the cavities or spaces defined between adjacent members and the respective protrusions of such members when compared to the outer plurality of buffer elements. In an embodiment, the outer buffer elements are circular in cross-section, whereas the inner buffer elements are tapered discorectangular in cross-section. Since the cavities or spaces into which the buffers are received are also substantially tapered discorectangular, the inner plurality of buffer elements substantially fills the space whereas the buffer elements having a circular cross section of the outer plurality of buffer elements have more space to deform into.

The hardness of the second plurality of buffer elements may be greater than that of the first plurality of buffer elements. Alternatively, the hardness of the first plurality of buffer elements can be greater than that of the second plurality of buffer elements. The hardness may be the same.

The cross sectional area of each of the first plurality of buffer elements can be greater than the cross sectional area of each of the second plurality of buffer elements, and vice versa. The cross-sectional areas may be the same.

The number of buffer elements of the first plurality of buffer elements may be greater than the number of buffer elements of the second plurality of buffer elements. The number of buffer elements of the second plurality of buffer elements may be greater than the number of buffer elements of the first plurality of buffer elements.

The inner member, the intermediate member and the outer member may each comprise a first side and a second side, the second side opposing the first side.

The inner member and/or the intermediate member and/or the outer member may comprise a plurality of apertures. The apertures may extend from the first side to the second side of a respective one of the inner member, the intermediate member and the outer member. The apertures may receive a respective axial buffer of a plurality of axial buffers.

The plurality of axial buffers may be provided as an array. Each axial buffer of the plurality of axial buffers may extend beyond the first side and/or second side of the respective one of the inner member, the intermediate member or the outer member.

Where the axial buffers are provided, axial vibration and axial movement of the coupling is advantageously buffered by the axial buffers. Since axial vibration is buffered by the axial buffers, the likelihood of damage to the coupling as a result of axial vibration is reduced.

The axial buffers and plurality of apertures may be configured such that the axial buffers are insertable and removable from a respective aperture with access to only one of the first side or the second side of the respective one of the inner member, the intermediate member or the outer member.

The axial buffers of the plurality of axial buffers may comprise a first end piece and a second end piece.

The axial buffers of the plurality of axial buffers may each further comprise a respective body. The first end piece and the second end piece of each axial buffer may be received by a respective body.

The body if the axial buffers may be configured to be secured within a respective opening.

At least part of the body may be threaded. The body may be threadably engageable with a respective aperture of the inner member, the intermediate member or the outer member.

The first plurality of buffer elements may fill a lower proportion of the space in which they are disposed than the second plurality of buffer elements.

According to a second aspect of the present invention, there is provided an assembly comprising the coupling as defined in the first aspect of the invention, a first shaft and a second shaft; wherein the first shaft is coupled to the inner member and the second shaft is coupled to the outer member.

According to a third aspect of the present invention, there is provided a marine vessel comprising the coupling as defined in the first aspect of the invention and/or the assembly as defined in the second aspect of the invention.

According to a fourth aspect of the present invention, there is provided a generator comprising the coupling as defined in the first aspect of the invention and/or the assembly as defined in the fourth aspect of the invention.

The generator can be a diesel generator.

According to a fifth aspect of the present invention, there is provided a buffer element for an elastic coupling, wherein said buffer element has a tapered discorectangular cross-section.

It will be appreciated that features described above with reference to one aspect of the invention may be combined with another aspect of the invention as appropriate.

### BRIEF DESCRIPTION OF THE DRAWINGS

Embodiments of the present invention will now be described, by way of example only, with reference to the accompanying drawings in which:

FIG. 1 depicts an end-on view of a coupling in accordance with an embodiment of the present invention;

FIG. 2 depicts a perspective view of an outer member of the coupling of FIG. 1;

FIG. 3 depicts a detail view of section A of FIG. 2;

FIG. 4 depicts a perspective view of an intermediate member of the coupling of FIG. 1;

FIG. 5a depicts a detail view of section B of FIG. 4;

FIG. 5b depicts a detail view of section C of FIG. 4;

FIG. 6 depicts a perspective view of an inner member of the coupling of FIG. 1;

FIG. 7 depicts a detail view of section D of FIG. 6;

FIG. 8 depicts a perspective view of a first plurality of buffer elements of the coupling of FIG. 1;

FIG. 9 depicts a perspective view of a second plurality of buffer elements of the coupling of FIG. 1;

FIG. 10 depicts a cross-sectional view of a buffer element of the second plurality of buffer elements of FIG. 9;

FIG. 11 depicts an exploded view of the coupling of FIG. 1;

FIG. 12 depicts an exploded view of an axial buffer of the coupling of FIG. 1;

FIG. 13 depicts an assembled view of the axial buffer of FIG. 12;

FIG. 14 depicts a finite element analysis model of the stress distribution of a known coupling during use;

FIG. 15 depicts a finite element analysis model of the stress distribution of the coupling of FIG. 1 during use; and

FIG. 16 depicts an end-on view of a coupling in accordance with an embodiment of the invention.

### DETAILED DESCRIPTION

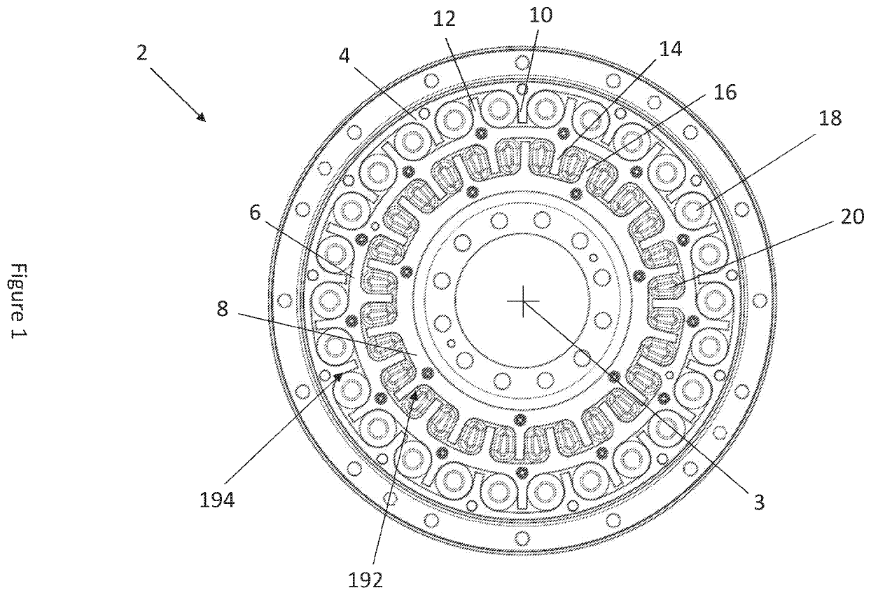

Referring first to FIG. 1, a coupling 2 is depicted. The coupling 2 can be used to connect a first shaft (not shown) to a second shaft (not shown). The coupling 2 can transfer a torque of at least 10 kNm. In some embodiments, the coupling 2 can transfer a torque of at least 30 kNm. In some embodiments, the coupling 2 can transfer a torque of at least 500 kNm. In some embodiments, the coupling 2 can transfer a torque of at least 1000 kNm. The coupling 2 defines a coupling axis 3. The coupling 2 comprises an outer member 4, an intermediate member 6 and an inner member 8. The outer member 4 is located radially outwards of the intermediate member 6 and the inner member 8. The intermediate member 6 is located radially between the outer member 4 and the inner member 8. The inner member 8 is located radially inwards of the outer member 4 and the intermediate member 6. The outer member 4 is generally annular. The intermediate member 6 is generally annular. The inner member 8 is generally annular. It will be appreciated that in other, non-depicted, embodiments the outer member 4, the intermediate member 6 and the inner member 8 can be any other suitable shape.

The outer member 4 comprises a plurality of radially inward projections 10 (only one of the radially inward projections is labelled in FIG. 1). The intermediate member 6 comprises a plurality of radially outward projections 12 (only one of the radially outward projections is labelled in FIG. 1). The intermediate member 6 also comprises a plurality of radially inward projections 14 (only one of the radially inward projections is labelled in FIG. 1). The inner member 8 comprises a plurality of radially outward projections 16 (only one of the radially inward projections is labelled in FIG. 1).

The plurality of radially inward projections 10 of the outer member 4 are radially overlapped with the plurality of radially outward projections 12 of the intermediate member 6. The plurality of radially inward projections 14 of the intermediate member 6 are radially overlapped with the plurality of radially outward projections 16 of the inner member 8. Since the projections 10, 12, 14, 16 of the members 4, 6, 8 of the coupling 2 are radially overlapped, the coupling is a fail-safe coupling. That is to say, the projections 10, 12, 14, 16 can engage one another in the event that the buffers fail.

The plurality of radially inward projections 10 of the outer member 4 are interdigitated with the plurality of radially outward projections 12 of the intermediate member 6. The plurality of radially inward projections 14 of the intermediate member 6 are interdigitated with the plurality of radially outward projections 16 of the inner member 8.

In the depicted embodiment, the outer member 4 comprises thirteen radially inward projections 10, although it will be appreciated that outer members having different numbers of radially inward projections are explicitly considered. The invention is not specifically limited to the depicted number of projections. The intermediate member 6 comprises thirteen radially outward projections 12. Again, it will be appreciated that this number is for example only and other numbers of projections are explicitly considered. Therefore, the number of radially inward projections 10 of the radially outer member 4 is equal to the number of radially outward projections 12 of the intermediate member 6. It will be appreciated that in other, non-depicted, embodiments, the number of radially inward projections 10 of the radially outer member 4 can be different to the number of radially outward projections 12 of the intermediate member 6.

The inner member 8 comprises fourteen radially outward projections 16. The intermediate member 6 comprises fourteen radially inward projections 14. Therefore, the number of radially outward projections 16 of the inner member 8 is equal to the number of radially inward projections 14 of the intermediate member 6. It will be appreciated that in other, non-depicted, embodiments, the number of radially outward projections 16 of the inner member 8 can be different to the number of radially inward projections 14 of the intermediate member 6. Again, it will also be appreciated that the exact number of projections may differ from the depicted embodiment and members having a different number of projections than depicted are explicitly considered.

Therefore, the number of radially inward projections 14 of the intermediate member 6 is greater than the number of radially outward projections 12 of the intermediate member. It follows that the number of radially outward projections 16 of the inner member 8 is greater than the number of radially inward projections 10 of the outer member 4. In other, non-depicted, embodiments the number of radially inward projections 14 of the intermediate member 6 can be equal to or less than the number of radially outward projections 12 of the intermediate member. It follows that the number of radially outward projections 16 of the inner member 8 can also be equal to or less than the number of radially inward projections 10 of the outer member 4.

The coupling 2 further comprises a first plurality of buffer elements 18 (only one of the buffer elements is labelled in FIG. 1) and a second plurality of buffer elements 20 (only one of the buffer elements is labelled in FIG. 1). Although only a single buffer element is depicted as being received in the space formed between the projections of adjacent members, in some embodiments more than one buffer member may be present in each such space. In use, the buffer elements of the first and second pluralities of buffer elements 18, 20 absorb at least partially a torsional vibration that is applied to the coupling 2 by a shaft (not shown in FIG. 1). Therefore, the coupling 2 is a flexible coupling. The coupling 2 can also be referred to as an elastic coupling. The buffer elements of the first and second plurality of buffer elements 18, 20 define the stiffness of the coupling 2. In particular, the buffer elements of the first and second plurality of buffer elements 18, 20 define the rotational stiffness of the coupling 2. Rotational stiffness can be described as the angle that the coupling 2 turns through when a given load is applied to the coupling. Given the coupling 2 rotates during use, the dynamic stiffness of the coupling 2 determines whether the coupling is suitable for a particular application. In other words, the dynamic stiffness of the coupling 2 determines whether the coupling will be able to sufficiently absorb vibrations during use. The buffer elements of the first plurality of buffer elements 18 can provide a different rotational stiffness than the buffer elements of the second plurality of buffer elements 20. Therefore, the coupling 2 can be provided with dual rotational stiffness.

The buffer elements of the first plurality of buffer elements 18 are positioned between, and are engaged by, adjacent radially inward projections 10 of the radially outer member 4 and radially outward projections 12 of the intermediate member 6. The buffer elements of the second plurality of buffer elements 20 are positioned between, and are engaged by, adjacent radially outward projections 16 of the radially inner member 8 and radially inward projections 14 of the intermediate member 6. The buffer elements 18, 20 are provided to absorb the torsional vibration of one of the shafts that the coupling is connected to during use. The first and second pluralities of buffer elements 18, 20 is discussed in more detail below.

Since the number of radially inward projections 14 of the intermediate member 6 can be greater than the number of radially outward projections 12 of the intermediate member 6, the second plurality of buffer elements 20 can comprise a greater number of buffer elements than the first plurality of buffer elements 18. This is beneficial because the second plurality of buffer elements 20 will be subject to greater loading during use, owing to the second plurality of buffer elements being located radially inwards of the first plurality of buffer elements 18.

The coupling 2 may further comprise a first plurality of axial buffers 21 and a second plurality of axial buffers 23. The first and second pluralities of axial buffers 21, 23 extend parallel to the coupling axis 3. The first plurality of axial buffers 21 is received by respective bores (not visible in FIG. 1) of the intermediate member 6. The second plurality of axial buffers 23 is received by respective bores of the inner member 8. The first and second pluralities of axial buffers 21, 23 are arranged in respective arrays. That is to say, the first plurality of axial buffers 21 are distributed evenly about a circumference of the intermediate member 6 and the second plurality of axial buffers 23 are distributed evenly about a circumference of the inner member 8. In alternative, non-depicted embodiments, the axial buffers are not provided. The first and second pluralities of axial buffers 21, 23 can be made of any suitable material. For example, the first and second pluralities of axial buffers 21, 23 can comprise rubber. The first and second plurality of axial buffers 21, 23 are discussed in more detail below. In some, non-depicted, embodiments, the coupling may further comprise a third plurality of axial buffers. The third plurality of axial buffers being received by respective bores of the outer member. The third plurality of axial buffers can be arranged as an array.

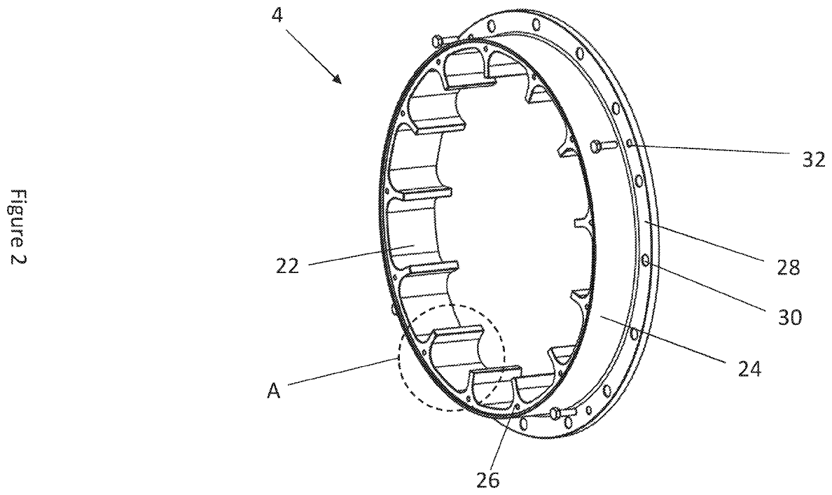

Referring now to FIG. 2, the outer member 4 is depicted. The outer member 4 comprises a radially internal surface 22. The outer member 4 further comprises a radially external surface 24. The outer member 4 further comprises a first side 26. The outer member 4 further comprises a second side (not visible in FIG. 2). The second side is opposed to the first side 26. A width of the outer member 4 is defined by the distance from the first side 26 to the second side in a direction parallel to the coupling axis (not shown in FIG. 2).

The outer member 4 may comprise a flange 28. The flange 28 extends from the second side of the outer member 4. The flange 28 extends radially beyond the radially external surface 24 in the radially outward direction. In other, non-depicted embodiments, the flange can extend radially inwards from the radially external surface. The flange 28 is provided with a first plurality of apertures 30 (only one of the apertures is labelled in FIG. 2). The flange 28 is provided with a second plurality of apertures 32 (only one of the apertures is labelled in FIG. 2). The first plurality of apertures 30 may or may not be threaded. The second plurality of apertures 32 may or may not be threaded. In use, a flange of a shaft (not shown in FIG. 2) is secured to the flange 28 of the outer member 4. Fasteners (not shown in FIG. 2) are inserted through the apertures of the first plurality of apertures 30 and through corresponding apertures of the flange of the shaft to secure the shaft to the outer member 4. The second plurality of apertures 32 receive fasteners (not shown in FIG. 2) that secure a cover (not shown in FIG. 2) to the second side of the outer member 4.

The plurality of radially inward projections 10 of the outer member 4 project from the radially internal surface 22 of the outer member. As can be seen, the plurality of radially inward projections 10 are arranged in an array. That is to say, the projections of the plurality of radially inward projections 10 are evenly distributed about the circumference of the outer member 4. In other, non-depicted embodiments, the plurality of radially inward projections can be distributed in a non-even fashion.

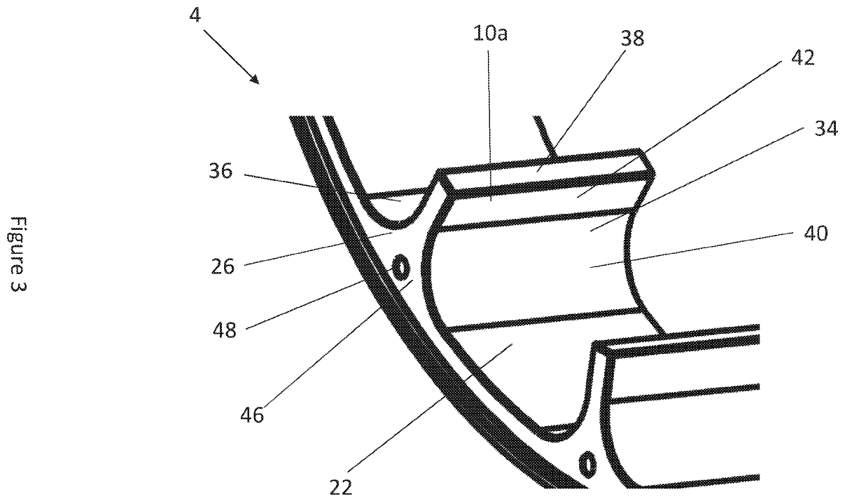

Referring now to FIG. 3, a detail view of the section A of FIG. 2 is shown. FIG. 3 depicts a radially inward projection 10a of the plurality of radially inward projections 10 of the outer member 4. It will be appreciated that the following description applies to all of the radially inward projections of the plurality of radially inward projections 10 of the outer member 4. As can be seen, the radially inward projection 10a extends from the first side 26 to the second side (not visible in FIG. 3) of the outer member 4. In other, non-depicted embodiments, one or more of the radially inward projections of the plurality of radially inward projections can be spaced apart from one or both of the first side and the second side of the outer member.

The radially inward projection 10a comprises a first engagement surface 34, a second engagement surface 36 and a distal surface 38. In use, the first and second engagement surfaces 36, 36 engage a respective buffer element of the first plurality of buffer elements 18. The distal surface 38 defines the radially innermost surface of the radially inward projection 10a. The first engagement surface 34 comprises a radiused section 40 and a radially extending section 42. The radiused section 40 extends between the radially internal surface 22 of the outer member 4 and the radially extending section 42. The radiused section 40 may be tangential to the radially extending section 42. The radiused section 40 may be tangential to the radially internal surface 22. It will be appreciated that the radiused section 40 need not extend tangentially to one or both of the radially internal surface 22 and the radially extending section 42. The radially extending section 42 extends between the radiused section 40 and the distal surface 38. The radially extending section 42 extends only in the radial direction. In other, non-depicted embodiments, the radially extending section can extend both in the radial and circumferential direction.

The second engagement surface 36 is generally identical to the first engagement surface 34. However, it will be appreciated that the second engagement surface 36 can have a different configuration to the first engagement surface 34.

The radially inward projection 10a comprises a base 46 that is defined circumferentially between the radiused sections 40 of the first and second engagement surfaces 34. The base 46 of the radially inward projection 10a may comprise a bore 48. The bore 48 extends from the first side 26 to the second side of the outer member 4. In alternative, non-depicted, embodiments, the base can be provided with two blind bores that extend from a respective one of the first side and the second side of the outer member. The bore 48 can be referred to as an opening. The bore 48 comprises threads (not visible). The bore 48 will be discussed in more detail below. In other embodiments, no bore is present.

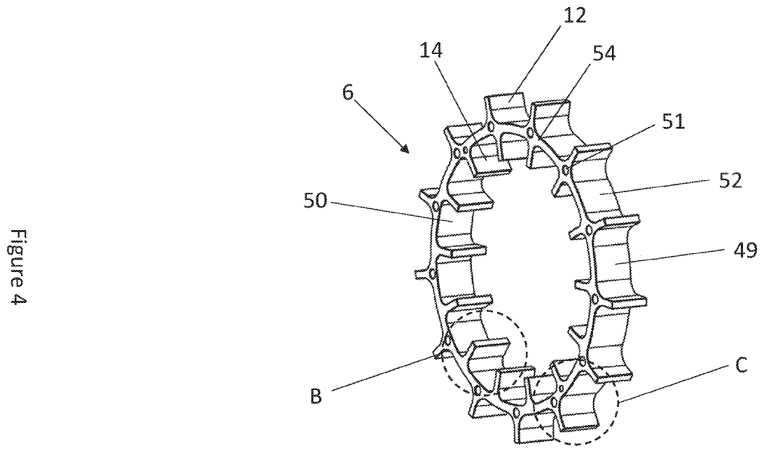

Referring now to FIG. 4, a perspective view of the intermediate member 6 is depicted. The intermediate member 6 comprises a first side 54. The intermediate member 6 further comprises a second side (not visible in FIG. 3). The second side is opposed to the first side 54. A width of the intermediate member 6 is defined by the distance from the first side 54 to the second side in a direction parallel to the coupling axis (not shown in FIG. 4). The intermediate member 6 comprises a body 49. The body 49 is generally annular. The body 49 comprises a radially internal surface 50. The body 49 further comprises a radially external surface 52.

The body 49 may be provided with a plurality of bores 51. The bores 51 extend from the first side 54 to the second side of the intermediate member. In alternative, non-depicted, embodiments the bores can be blind bores. In other embodiments, no bores are present. The bores 51 can be referred to as openings. The position of the bores 51 corresponds with the position of the radially outward projections 12 of the intermediate member 6. This ensures that the material thickness in the region of the bores 51 is maximised. That is to say, the bores 51 are located directly radially adjacent to the radially outward projections 12. It will be appreciated that the position of the bores 51 can correspond with the position of the radially inward projections 14 of the intermediate member 6. Alternatively, the bores 51 can be located circumferentially between the radially inward projections 14 and the radially outward projections 12. At least part of the bores 51 may be threaded. The bores 51 each receive an axial buffer of the first plurality of axial buffers 21.

The plurality of radially outward projections 12 project from the radially external surface 52 of the body 49 of the intermediate member 6. The plurality of radially inward projections 14 project from the radially internal surface 50 of the body 49. The plurality of radially outward projections 12 are arranged in an array. The plurality of radially inward projections 14 are arranged in an array. That is to say, the projections of the plurality of radially outward projections 12 and of the plurality of radially inward projections 14 are evenly distributed about the circumference of the body 49. In other, non-depicted embodiments, one or both of the plurality of radially outward projections and the radially inward projections can be distributed in a non-even fashion.

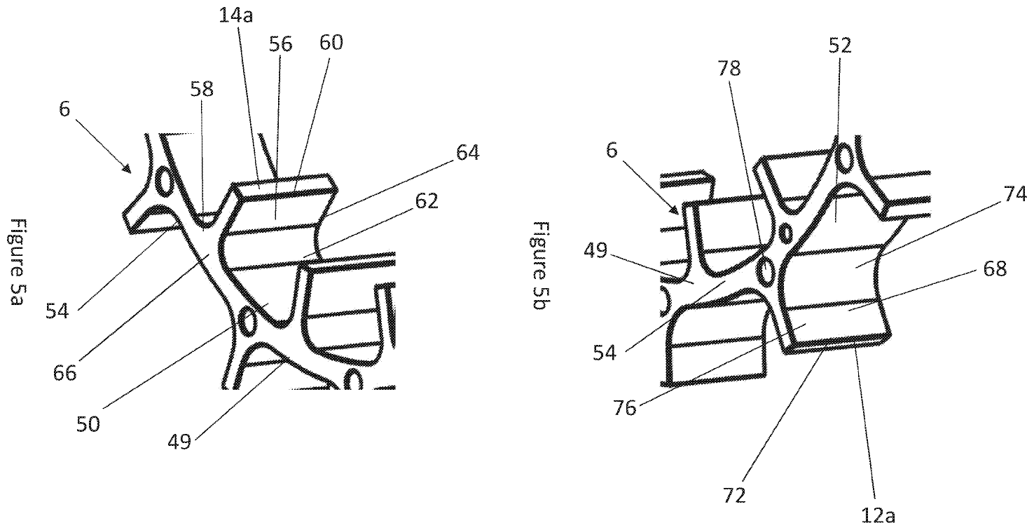

Referring now to FIG. 5a, a detail view of the section B of FIG. 4 is shown. FIG. 5a depicts a radially inward projection 14a of the plurality of radially inward projections 14 of the intermediate member 6. It will be appreciated that the following description applies to all of the radially inward projections of the plurality of radially inward projections 14 of the intermediate member 6. As can be seen, the radially inward projection 14a extends from the first side 54 to the second side (not visible in FIG. 5a) of the intermediate member 6. In other, non-depicted embodiments, one or more of the radially inward projections of the plurality of radially inward projections can be spaced apart from one or both of the first side and the second side of the intermediate member.

The radially inward projection 14a comprises a first engagement surface 56, a second engagement surface 58 and a distal surface 60. In use, the first and second engagement surfaces 56, 58 engage a respective buffer element of the second plurality of buffer elements (not shown in FIG. 5a). The distal surface 60 defines the radially innermost surface of the radially inward projection 14a. The first engagement surface 56 comprises a radiused section 62 and a radially extending section 64. The radiused section 62 extends between the radially internal surface 50 of the body 49 of the intermediate member 6 and the radially extending section 64. The radiused section 62 is tangential to the radially extending section 64. The radiused section 62 is tangential to the radially internal surface 50. It will be appreciated that the radiused section 62 need not extend tangential to one or both of the radially internal surface 50 and the radially extending section 64. The radially extending section 64 extends between the radiused section 62 and the distal surface 60. The radially extending section 64 extends only in the radial direction. In other, non-depicted embodiments, the radially extending section can extend both in the radial and circumferential direction.

The second engagement surface 58 is generally identical to the first engagement surface 56. However, it will be appreciated that the second engagement surface 58 can have a different configuration to the first engagement surface 56.

The radially inward projection 14a comprises a base 66 that is defined circumferentially between the radiused sections 62 of the first and second engagement surfaces 58.

Referring now to FIG. 5b, a detailed view of the section C of FIG. 4 is shown. FIG. 5b depicts a radially outward projection 12a of the plurality of radially outward projections of the intermediate member 6. It will be appreciated that the following description applies to all of the radially outward projections of the plurality of radially outward projections of the intermediate member 6. As can be seen, the radially outward projection 12a extends from the first side 54 to the second side (not visible in FIG. 5a) of the intermediate member 6. In other, non-depicted embodiments, one or more of the radially outward projections of the plurality of radially outward projections can be spaced apart from one or both of the first side and the second side of the intermediate member.

The radially outward projection 12a comprises a first engagement surface 68, a second engagement surface (not visible in FIG. 5b) and a distal surface 72. In use, the first and second engagement surfaces 68 engage a respective buffer element of the first plurality of buffer elements (not shown in FIG. 5b). The distal surface 72 defines the radially outermost surface of the radially outward projection 12a. The first engagement surface 68 comprises a radiused section 74 and a radially extending section 76. The radiused section 74 extends between the radially external surface 52 of the body 49 of the intermediate member 6 and the radially extending section 76. The radiused section 74 is tangential to the radially extending section 76. The radiused section 74 is tangential to the radially external surface 52 of the body 49. It will be appreciated that the radiused section 74 need not extend tangential to one or both of the radially external surface 52 and the radially extending section 76. The radially extending section 76 extends between the radiused section 74 and the distal surface 72. The radially extending section 76 extends only in the radial direction. In other, non-depicted embodiments, the radially extending section can extend both in the radial and circumferential direction.

The second engagement surface is generally identical to the first engagement surface 68. However, it will be appreciated that the second engagement surface can have a different configuration to the first engagement surface 68.

The radially outward projection 12a comprises a base 78 that is defined circumferentially between the radiused sections 74 of the first and second engagement surfaces 68.

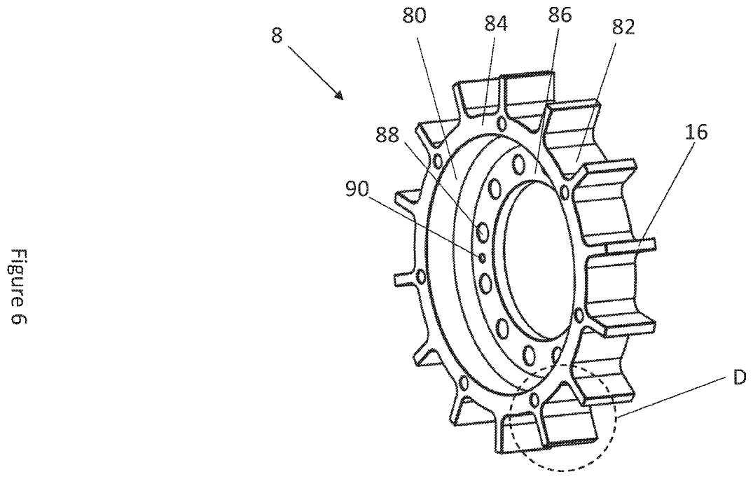

Referring now to FIG. 6, the inner member 8 is depicted. The inner member 8 comprises a radially internal surface 80. The inner member 8 further comprises a radially external surface 82. The inner member 8 further comprises a first side 84. The inner member 8 further comprises a second side (not visible in FIG. 6). The second side is opposed to the first side 84. A width of the inner member 6 is defined by the distance from the first side 84 to the second side in a direction parallel to the coupling axis (not shown in FIG. 6).

The inner member 8 may comprise a flange 86. The flange 86 extends from the second side of the inner member 8. The flange 86 extends radially inwards from the radially external surface 82. In other, non-depicted embodiments, the flange can extend radially outwards from the radially external surface. The flange 86 may be provided with a first plurality of apertures 88 (only one of the labelled is visible in FIG. 6). The flange 86 may be provided with a second plurality of apertures 90 (only one of the apertures is visible in FIG. 6). The first plurality of apertures 88 may or may not be threaded. The second plurality of apertures 90 may or may not be threaded. The apertures 90 are optional. In use, a flange of a shaft (not shown in FIG. 6) is secured to the flange 86.

Fasteners are inserted through the apertures of the first plurality of apertures 88 and through corresponding apertures of the flange of the shaft to secure the shaft to the inner member 8.

The plurality of radially outward projections 16 of the inner member 8 project from the radially external surface 82 of the inner member. As can be seen, the plurality of radially outward projections 16 are arranged in an array. That is to say, the projections of the plurality of radially outward projections 16 are evenly distributed about the circumference of the inner member 8. In other, non-depicted embodiments, the plurality of radially outward projections can be distributed in a non-even fashion.

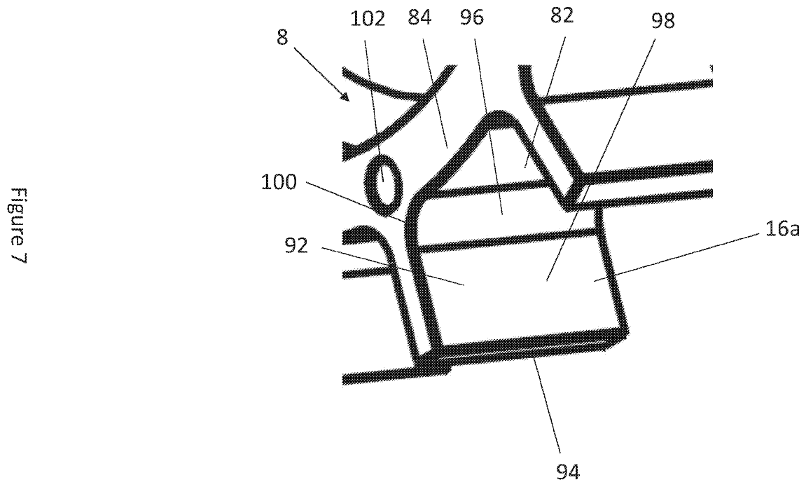

Referring now to FIG. 7, a detail view of the section D of FIG. 6 is shown. FIG. 7 depicts a radially outward projection 16a of the plurality of radially outward projections 16 of the inner member 8. It will be appreciated that the following description applies to all of the radially outward projections of the plurality of radially outward projections 16 of the inner member 8. As can be seen, the radially outward projection 16a extends from the first side 84 to the second side (not visible in FIG. 7) of the inner member 8. In other, non-depicted embodiments, one or more of the radially outward projections of the plurality of radially outward projections can be spaced apart from one or both of the first side and the second side of the inner member.

The radially outward projection 16a comprises a first engagement surface 92, a second engagement surface (not visible in FIG. 7) and a distal surface 94. In use, the first and second engagement surfaces 92 engage a respective buffer element of the second plurality of buffer elements 20. The distal surface 94 defines the radially outermost surface of the radially outward projection 16a. The first engagement surface 92 comprises a radiused section 96 and a radially extending section 98. The radiused section 96 extends between the radially external surface 82 of the inner member 8 and the radially extending section 98. The radiused section 96 is tangential to the radially extending section 98. The radiused section 96 is tangential to the radially external surface 82. It will be appreciated that the radiused section 96 need not extend tangentially to one or both of the radially external surface 82 and the radially extending section 98. The radially extending section 98 extends between the radiused section 96 and the distal surface 94. The radially extending section 98 may extend only in the radial direction. In other, non-depicted embodiments, the radially extending section can extend both in the radial and circumferential direction.

The second engagement surface is generally identical to the first engagement surface 92. However, it will be appreciated that the second engagement surface can have a different configuration to the first engagement surface 92.

The radially inward projection 16a may comprise a base 100 that is defined circumferentially between the radiused sections 96 of the first and second engagement surfaces 92.

The base 100 of the radially outward projection 16a may comprise a bore 102. The bore 102 extends from the first side 84 to the second side of the inner member 8. In alternative, non-depicted, embodiments the bore can be a blind bore. The bore 102 can be referred to as an opening. At least part of the bore 102 is threaded. The bore 102 will be discussed in more detail below. In embodiments, the bore may be absent.

The outer member 4, the intermediate member 6 and the inner member 8 can be made of any suitable material. It will be appreciated that the outer member 4, the intermediate member 6 and the inner member 8 need not be made of the same material. The outer member 4 and/or the intermediate member 6 and/or the inner member 8 can be made of a metallic material. Suitable metallic materials include but are not limited to cast iron, steel or aluminium. The outer member 4 and/or the intermediate member 6 and/or the inner member 8 can be made of a non-metallic material. Suitable non-metallic materials include but are not limited to plastics, carbon fibre, glass-reinforced plastic or another suitable fibre-impregnated material. It will be appreciated that the material from which the outer member 4, the intermediate member 6 and the inner member 8 are made of should be suitable for the torque that the coupling is intended to transfer.

The width of the outer member 4, the intermediate member 6 and the inner member 8 is approximately equal. In other, non-depicted embodiments, the widths of the width of the outer member 4, the intermediate member 6 and the inner member 8 can be non-equal. For example, the width of the inner member 8 can be greater than the width of the intermediate member 6 and of the outer member 4, or vice versa.

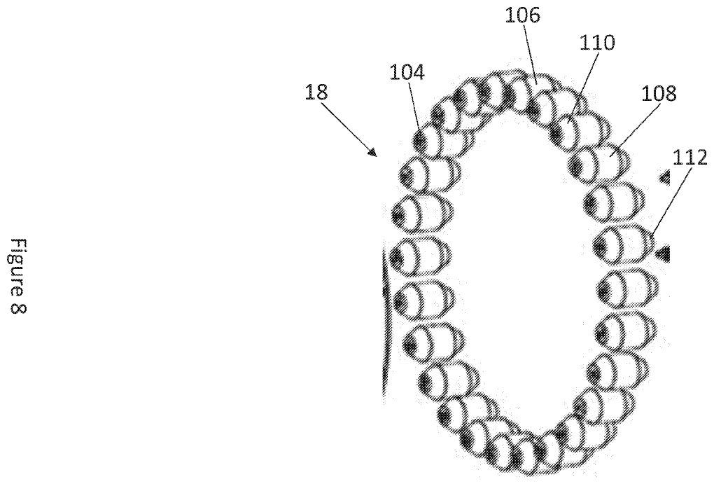

Referring now to FIG. 8, the first plurality of buffer elements 18 (only one of the buffer elements is labelled in FIG. 8) are depicted. As can be seen, the first plurality of buffer elements 18 is arranged in an array. That is to say, the first plurality of buffer elements 18 are evenly distributed in a circular manner.

The buffer elements of the first plurality of buffer elements 18 each comprise a first end surface 104 and a second end surface (not visible in FIG. 8). The second end surface is opposite to the first end surface 104. The first and second end surfaces 104 define the absolute ends of the buffer elements of the first plurality of buffer elements 18 in a direction parallel to the coupling axis (not shown in FIG. 8). The buffer elements of the first plurality of buffer elements 18 further comprise an external surface 106. The external surface 106 of each buffer element 18 comprises a central region 108, a first end region 110 and a second end region 112. The first end region 110 is located adjacent to the first end surface 104. The second end region 112 is located adjacent to the second end surface. The central region 108 is interposed between the first end region 110 and the second end region 112. The buffer elements may be substantially cylindrical in shape with chamfered portions at each end.

When the first plurality of buffer elements 18 are assembled into the coupling, the first end surface 104 of each of the buffer elements is located adjacent to the first side 22 of the outer member 4 and to the first side 54 of the intermediate member 6. Similarly, the second end surface of each of the buffer elements of the first plurality of buffer elements is located adjacent to the second side of the outer member 4 and to the second side of the intermediate member 6.

The central region 108 is circular in radial cross-section. In other, non-depicted, embodiments the central region can be any other suitable shape in radial cross-section. For example, the central region can be ovular, triangular, or discorectangular in radial cross-section. The central region 108 is of constant outside diameter. In alternative, non-depicted embodiments, the outside diameter of the central region can be non-constant.

For example, the outside diameter of the central region at a mid-point of the central region can define a minimum outside diameter of the central region. Where the mid-point of the central region defines the minimum outside diameter of the central region, the first plurality of buffer elements are referred to as being “waisted”. The mid-point of the central region 108 is the point of the central region that is located equidistant between the first end surface 104 and the second end surface of the buffer elements 18.

The radius of the central region 108 corresponds with the radii of the radiused sections of the engagement surfaces 34 of the radially inward projections 10 of the outer member 4 and of the radiused sections 74 of the engagement surfaces 68 of the radially outward projections 12 of the intermediate member 6.

The external surface 106 of the first plurality of buffer elements 18 may be chamfered at first end region 110 and the second end region 112. That is to say, the outside diameter of the buffer elements of the first plurality of buffer elements 18 decreases linearly between the point of the first end region 110 that is adjacent to the central region 108 and the first end surface 104, and between the point of the second end region 112 that is adjacent to the central region and the second end surface. In other, non-depicted, embodiments, the first end region and/or the second end region can be radiused. In further alternative, non-depicted embodiments, outside diameter of the first end region and/or of the second end region can be constant. It will be appreciated that any combination of these features can be applied to the first end region 110 and the second end region 112. For example, the first end region 110 can be chamfered and the second end region can be radiused, or the first end region can be radiused and the second end region can be of constant outside diameter.

The length buffer elements of the first plurality of buffer elements 18 may substantially correspond with the width of the outer member 4 and the intermediate member 6. The length of the buffer elements of the first plurality of buffer elements 18 is defined as the distance from the first end surface 104 to the second end surface in a direction parallel to the coupling axis (not shown in FIG. 8). The length of the buffer elements of the first plurality of buffer elements 18 is approximately equal to the width of the outer member 4 and of the intermediate member 6. In other, non-depicted, embodiments, the length of the buffer elements of the first plurality of buffer elements can be greater or less than the width of the outer member and of the intermediate member. It will be appreciated that the buffer elements of the plurality of buffer elements need not be of the same length. The length of some of the buffer elements can be equal to the width of the outer member and of the intermediate member, the length of some of the buffer elements can be greater than the width of the outer member and of the intermediate member, and the length of some of the buffer elements can be less than the width of the width of the outer member and of the intermediate member.

In the depicted embodiment, the first plurality of buffer elements 18 is provided as a single row of buffer elements. In other, non-depicted embodiments, the first plurality of buffer elements can be provided as two axially adjacent rows of buffer elements. That is to say, a first row of buffer elements can be located adjacent to the first side of the outer member and to the first side of the intermediate member and a second row of buffer elements can be located adjacent to the second side of the outer member and to the second side of the intermediate member. The first row and the second row can be arranged as an array. Where the first plurality of buffer elements is provided as two axially adjacent rows the buffer elements of the rows can combine any of the features described above in relation to the first plurality of buffer elements that have been described in relation to FIG. 8 where appropriate.

In FIG. 8, the buffer elements of the first plurality of buffer elements 18 are identical. In other, non-depicted embodiments, the shape and/or size of the buffer elements of the first plurality of buffer elements 18 can vary.

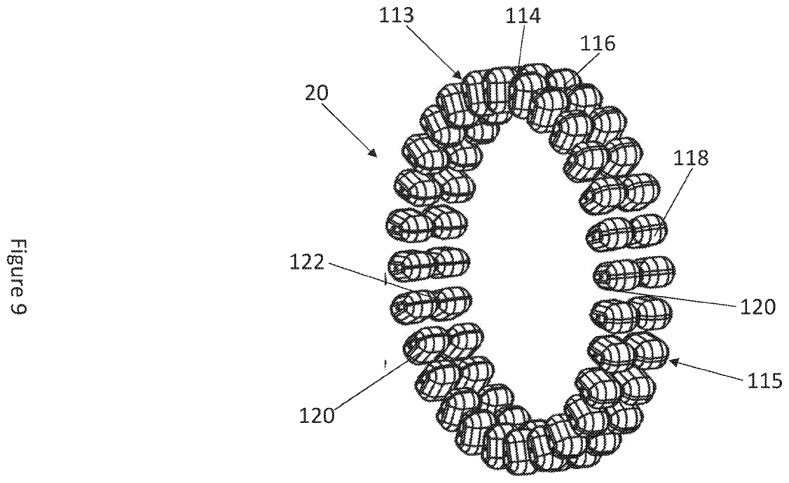

Referring now to FIG. 9, the second plurality of buffer elements 20 (only one of the buffer elements is labelled in FIG. 9) are depicted. As can be seen, the second plurality of buffer elements 20 are arranged in a first row 113 and a second row 115. The first row 113 is axially adjacent to the second row 115. That is to say, the second plurality of buffer elements 20 are arranged in two rows that are located next to one another in the direction of the coupling axis (not shown in FIG. 9). The first row 113 and the second row 115 are arranged as arrays. That is to say, the buffer elements of each row 113, 115 are evenly distributed in a circular manner. It will be appreciated that in embodiments, there may only be a single row of buffer elements or there may be more than two rows of buffer elements.

The buffer elements of the second plurality of buffer elements 20 each comprise a first end surface 114 and a second end surface (not visible in FIG. 9). The second end surface is opposed to the first end surface 114. The first and second end surfaces 114 define the absolute ends of the buffer elements of the second plurality of buffer elements in a direction parallel to the coupling axis (not shown in FIG. 9). The buffer elements of the second plurality of buffer elements 20 further comprise an external surface 116.

The external surface 116 of each buffer element 20 comprises a central region 118, a first end region 120 and a second end region 122. The first end region 120 is located adjacent to the first end surface 114. The second end region 122 is located adjacent to the second end surface.

When the second plurality of buffer elements 20 are assembled into the coupling, the first end surface 114 of each of the buffer elements of the first row 113 is located adjacent to the first side 84 of the inner member 8 and to the first side 54 of the intermediate member 6. Similarly, the first end surface 114 of each of the buffer elements of the second row 115 is located adjacent to the second side of the inner member 8 and to the second side of the intermediate member 6. The second end surface of each of the buffer elements of the first and second rows 113, 115 is located generally equidistant between the first side 84 and the second side of the inner member 8 and equidistant between the first side 54 and the second side of the intermediate member 6. In other, non-depicted, embodiments the second plurality of buffer elements 20 can be provided as a single row.

That is to say, the first end surface of each of the buffer elements can be located adjacent to the first side of the inner member and to the first side of the intermediate member. Similarly, the second end surface of each of the buffer elements can be located adjacent to the second side of the inner member and to the second side of the intermediate member.

The first and second end regions 120, 122 may be formed as curved surfaces that extend from the respective one of the first end surface 114 and the second end surface to the central region 118 of the external surface 116. The curved surfaces that form the first and second end regions 120, 122 are formed such that they adjoin the periphery of the respective end surfaces 114 and the periphery of the central region of the external surface. The radii of the first end region 120 are tangential to the first end surface 114 and to the central region 118 of the external surface 116. The radius of the second end region 122 are tangential to the second end surface and to the central region 118 of the external surface 116. The curved surfaces of the first and second end regions 120, 122 are formed of multiple radii. That is to say, the curved surfaces of the first and second end regions 120, 122 are of non-uniform radius. In other, non-depicted, embodiments, the radii of the first end region and/or the second end region need not be tangential to the first end surface and/or to the central region of the external surface 116. In further, non-depicted embodiments, the first end region and/or the second region need not be formed as curved surfaces. For example, the first end region and/or the second end region can be formed as chamfered surfaces. That is to say, the surface of the first end region and/or the second end region can taper from the central region of the external surface to the respective one of the first or second end surface 114As a further example, the first end region and/or the second end region can extend parallel to the central region of the external surface. That is to say, the cross-sectional shape of the buffer elements of the second plurality of buffer elements can be generally uniform between the first and second end surfaces.

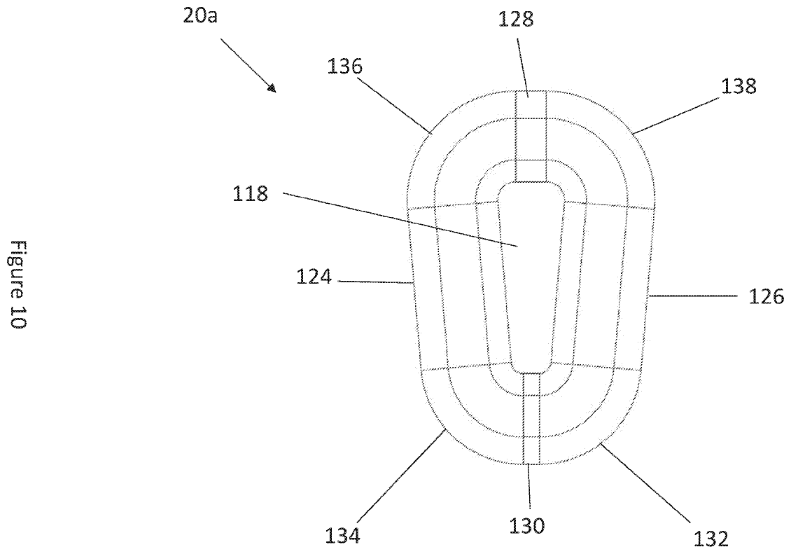

Referring now to FIG. 10, a buffer element 20a of the second plurality of buffer elements is shown in radial perspective. As can be seen, the buffer element 20a comprises two radially extending linear regions 124, 126. The two radially extending linear regions 124, 126 extend in a generally radial direction when the buffer element 20a has been assembled into the coupling. Therefore, the circumferential width of the buffer element 20a reduces in the radially inward direction. The circumferential width being defined as the distance in the circumferential direction between the two radially extending linear regions. The buffer element 20a further comprises two circumferentially extending linear regions 128, 130. The two circumferentially extending linear regions 128, 130 extend in a generally circumferential direction when the buffer element 20a has been assembled into the coupling. The buffer element 20a further comprises four arcuate regions 132, 134, 136, 138. The arcuate regions 132, 134, 136, 138 are alternately arranged between the linear regions 124, 126, 128, 130. Each of the arcuate regions 132, 134, 136, 138 extend tangentially from respective linear regions 124, 126, 128, 130. The cross-sectional shape of the buffer element 20a is therefore generally discorectangular. In particular, the cross-sectional shape of the buffer element 20a is a tapered discorectangle.

When the buffer element 20a has been assembled into the coupling, two of the arcuate regions 132, 134 are radially inner arcuate regions and two of the arcuate regions 136, 138 are radially outer arcuate regions. The radii of the radially inner arcuate regions 132, 134 generally correspond with the radii of the radiused sections 96 of the engagement surfaces 92 of the radially outward projections 16 of the inner member 8. The radii of the radially outer arcuate regions 136, 138 generally corresponds with the radii of the radiused sections 62 of the engagement surfaces 56 of the radially inward projections 14 of the intermediate member 6.

The buffer elements of the first and second pluralities of buffer elements 18, 20 can be made of any suitable material. For example, the buffer elements can be made of a rubber material. In some embodiments, the hardness of the buffer elements of the second plurality of buffer elements 20 can be greater than the hardness of the buffer elements of the first plurality of buffer elements 18. In some embodiments, the hardness of the buffer elements of the second plurality of buffer elements 20 can be less than or equal to the hardness of the buffer elements of the first plurality of buffer elements 18.

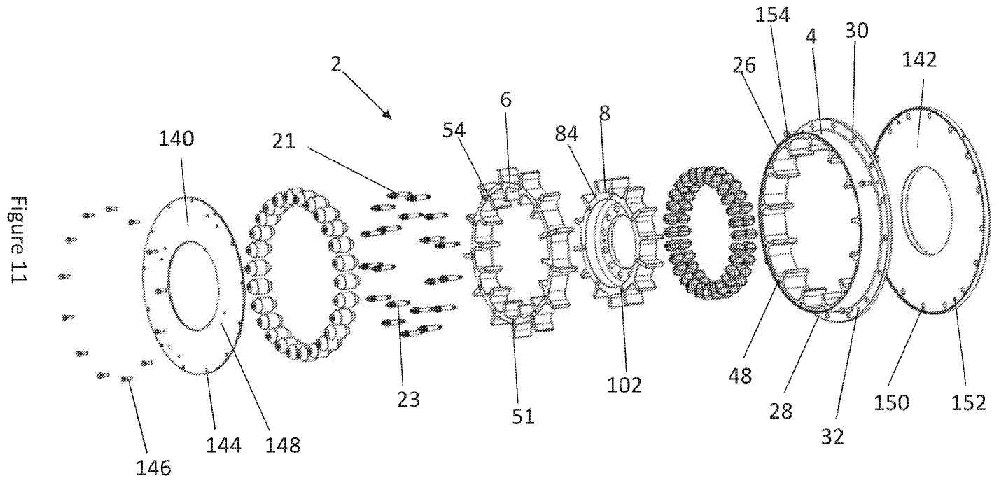

Referring now to FIG. 11, an exploded view of the coupling 2 is depicted. The coupling 2 further comprises a first end plate 140 and a second end plate 142. When the coupling 2 has been assembled, the first end plate 140 is located adjacent to the first sides 26, 54, 84 of the outer member 4, the intermediate member 6 and the inner member 8. Similarly, when the coupling 2 has been assembled, the second end plate 142 is located adjacent to the second sides of the outer member 4, the intermediate member 6 and the inner member 8. The first and second end plates 140, 142 are annular. In other, non-depicted embodiments, the first and second end plates can be disc-shaped.

The first end plate 140 comprises a radially outer plurality of apertures 144 (only one of the apertures is labelled in FIG. 11). The radially outer plurality of apertures 144 are provided adjacent to the periphery of the first end plate 140. The radially outer plurality apertures 144 are provided as an array. The position of the apertures of the radially outer plurality of apertures 144 corresponds with the position of the bores 48 of the outer member 4. A plurality of fasteners 146 extend through respective apertures of the radially outer plurality of apertures 144. The fasteners of the plurality of fasteners 146 engage the threads of the bores 48 of the outer member 4. The plurality of fasteners 146 therefore secure the first end plate 140 to the outer member 4. The first end plate further comprises a radially inner plurality of apertures 148. Again, the apertures are optional.

The second end plate 142 comprises a first plurality of apertures 150 (only one of the apertures is labelled in FIG. 11). The first plurality of apertures 150 are provided adjacent to the periphery of the second end plate 142. The first plurality apertures 150 are provided as an array. The position of the apertures of the first plurality of apertures 150 corresponds with the position of the first plurality of apertures 30 (only one of the apertures of the first plurality of apertures is labelled in FIG. 11) of the flange 28 of the outer member 4. When a shaft (not shown in FIG. 11) is secured to the coupling 2, the fasteners (not shown in FIG. 11) that secure the shaft to the coupling 2 extend through the first plurality of apertures 30 of the flange 28 of the outer member 4 and through the first plurality of apertures 150 of the second end plate 142.

The second end plate further comprises a second plurality of apertures 152 (only one of the apertures is labelled in FIG. 11). The second plurality of apertures 152 are provided adjacent to the periphery of the second end plate 142. The second plurality apertures 152 are provided as an array. The position of the apertures of the second plurality of apertures 152 corresponds with the position of the second plurality of apertures 32 (only one of the apertures of the second plurality of apertures is labelled in FIG. 11) of the flange 28 of the outer member 4. The apertures are optional. When the coupling 2 is assembled, a plurality of fasteners 154 (only one of the fasteners is labelled in FIG. 11) extend through the second plurality of apertures 32 of the flange 28 of the outer member 4 and through the second plurality of apertures 152 to secure the second end plate 142 to the outer member 142.

As can be seen, the radial position of each of the first plurality of axial buffers 21 corresponds with the radial position respective bores of the plurality of bores 51 of the intermediate member 6. Similarly, the radial position of each of the second plurality of axial buffers 23 corresponds with the radial position respective bores of the plurality of bores 102 of the inner member 8.

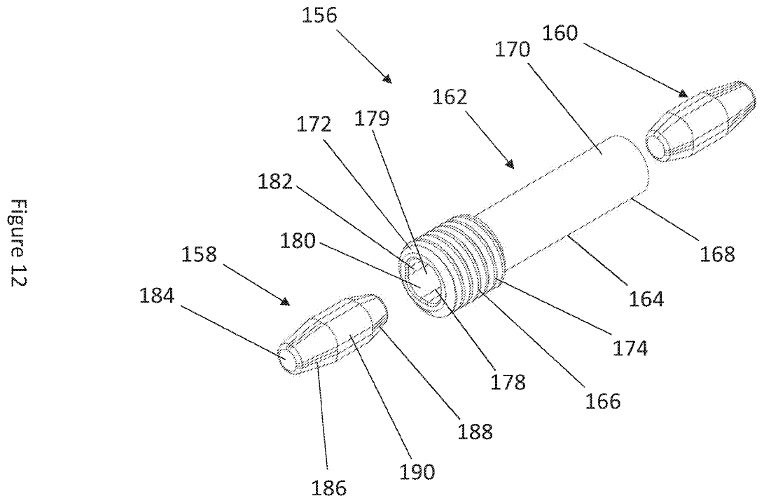

Referring now to FIG. 12, an axial buffer 156 is shown. The axial buffer 156 is one of the axial buffers of the first and second plurality of axial buffers 21, 23. The axial buffer 156 comprises a first end piece 158, a second end piece 160 and a body 162. In other, non-depicted, embodiments, the body need not be provided. The body 162 is elongate. The body 162 is generally cylindrical. The first end piece 158 and the second end piece 160 are received by the body 162. The body 162 comprises a central region 164, a first end region 166 and a second end region 168. The body 162 further comprises an external surface 170, a first end face 172 and a second end face (not visible in FIG. 12). The second end face is opposed to the first end face 172. The first and second end faces 172 define respective absolute ends of the body 162.

The external surface 170 of the body 162 comprises a threaded portion 174. In particular, the first end 166 of the body 164 comprises the threaded region 174. The threaded portion 174 extends from the first end face 172 towards the central region 170 of the body 162. In other, non-depicted, embodiments, the threaded portion can be offset from the first end face. Alternatively, the threaded portion can extend from the first end face to the second end face.

The first end face 174 comprises a first bore 178. The second end face comprises a second bore (not visible in FIG. 12). The second bore is generally identical to the first bore 178. The following description of the first bore 178 therefore applies mutatis mutandis to the second bore. However, the second bore can comprise any of the features described in relation to the first bore 178.

The first bore 178 is a blind bore. In other, non-depicted embodiments, the first bore can extend from the first end face to the second end face. The first bore 178 defines a sidewall 179. The sidewall 179 comprises a plurality of arcuate regions 180 (only one of the arcuate regions is labelled in FIG. 12) and a plurality of linear regions 182 (only one of the linear regions is labelled in FIG. 12). The sidewall 179 is therefore discontinuous. That is to say, the sidewall 179 comprises vertices. The plurality of linear regions 180 are alternately arranged between the arcuate regions 182. The plurality of arcuate regions 180 comprises four arcuate regions. It will be appreciated that any suitable number of arcuate regions 180 can be provided. For example, between two and ten arcuate regions can be provided. The number of linear regions 182 corresponds with the number of arcuate regions 180. In other, non-depicted, embodiments the number of linear regions can be greater than or less than the number of arcuate regions. In further, non-depicted, embodiments the first bore only comprises linear regions or arcuate regions. The profile defined by the sidewall 179 allows a tool, such as an allen key, to engage the sidewall 179 to rotate the body 162.

The first end piece 158 is generally identical to the second end piece 160. Therefore, the following description of the first end piece 158 applies mutatis mutandis to the second end piece 160. However, the second end piece 160 can comprise any combination of the features described in relation to the first end piece 158.

The first end piece 158 comprises a first end face 184 and a second end face (not visible in FIG. 12). The second end face is opposed to the first end face 184. The first end piece further comprises a first end region 186, a second end region 188 and a central region 190. The first end region 186 adjoins the central region 190 and the first end face 184. The second end region 188 adjoins the central region 190 and the second end face.

The profile defined by the central region 190 corresponds with the profile defined by the sidewall 179 of the first bore 178.

The first end region 186 tapers from the central region 190 to the first end face 184. The second end region tapers from the central region 190 to the second end face. That is to say, the thicknesses of the first and second end regions 186 reduce from the central region 190 to a respective one of the first end face 184 and the second end face.

The first and second end regions 186 each define a respective length that extends from the respective one of the first and second end faces 184 to the central region in a direction parallel to the coupling axis (not shown in FIG. 12). The length of the first end region 186 is greater than the length of the second end region 188. In other, non-depicted, embodiments, the length of the first end region can be equal to or less than the length of the second end region.

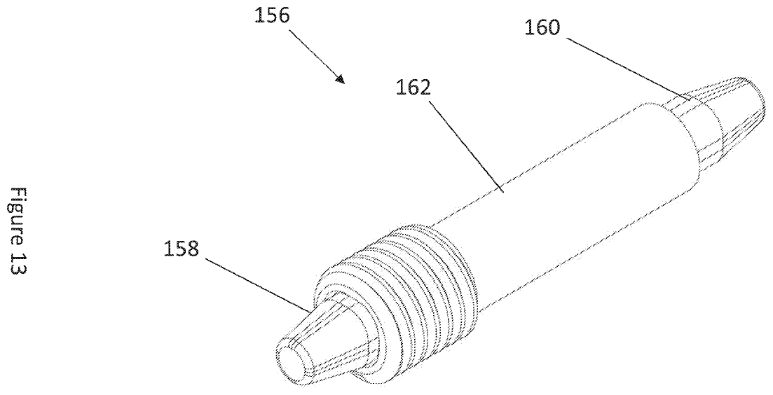

Referring to FIG. 13, an assembled axial buffer 156 is shown. As can be seen, the first end piece 158 and the second end piece 160 are received by the body 162. The first end piece 158 and the second end piece 160 can be manually inserted into the respective one of the first bore 178 and the second bore of the body 162.

Referring to FIGS. 11 to 13, to assemble an axial buffer 156 into the intermediate member 6 or the inner member 8, the second end piece 160 is first inserted into the second bore of the body 170. The second end piece 160 and the body 162 are then inserted into one of the bores 51, 102 of the intermediate member 6 or the inner member 8. A tool is then used to engage the threads of the threaded portion 174 with the threads of the bore 51, 102. The body 170 is then tightened into the bore 51, 102. Finally, the first end piece 158 is inserted into the first bore 178 of the body 170. The axial buffer 156 can therefore be inserted and removed from the intermediate member 6 or of the inner member 8 with access to only one side of the intermediate member or the inner member.

Referring again to FIG. 11, when the first plurality of axial buffers 21 have been received by the bores 51 of the intermediate member 6, at least part of the first end piece and the second end piece projects beyond the respective one of the first side 26 and the second side (not visible in FIG. 11) of the intermediate member. Similarly, when the second plurality of axial buffers 23 have been received by the bores 102 of the inner member 8, at least part of the first end piece and the second end piece projects beyond the respective one of the first side 84 and the second side (not visible in FIG. 11) of the inner member. The axial buffers 21, 23 therefore buffer axial movement of the respective one of the intermediate member 6 and the inner member 8.

Referring again to FIG. 1, the coupling 2 defines a first torque transfer zone 192 and a second torque transfer zone 194. The torque transfer zones 192, 194 allow the coupling 2 to transfer a torque applied to a first shaft (not shown in FIG. 1) to a second shaft (not shown in FIG. 1). The first torque transfer zone 192 is defined by the radially outward projections 16 of the inner member 8, the second plurality of buffer elements 20 and the radially inward projections 14 of the intermediate member 6. The second torque transfer zone 194 is defined by the radially inward projections 10 of the outer member 4, the first plurality of buffer elements 18 and the radially outward projections 12 of the intermediate member 6. Therefore, the first torque transfer zone 192 is located radially adjacent to the second torque transfer zone 194. In particular, the first torque transfer zone 192 is located radially inwards of the second torque transfer zone 194. This configuration advantageously reduces the weight of the coupling and the volume occupied by the coupling compared to known configurations that include two torque transfer zones. Known configurations to achieve two torque transfer zones typically include two separate couplings that are positioned axially adjacent to one another.

Therefore, this known configuration requires two separate coupling to be manufactured and requires each coupling to be individually secured to the shafts that are connected by the couplings. This requires additional manufacturing and assembly time compared to the coupling 2. In addition, the weight and volume of two separate couplings is greater than the volume and weight of the coupling 2.

The torque transfer capacity of the coupling 2 may be described as the torque that can be applied to the coupling during use. In general, the torque transfer of a flexible or elastic coupling is limited by the stress that the buffer elements of the coupling is subjected to in use. The shear strength of materials or components may be significantly less than the compressive strength of the material or component. Since the engagement surfaces 34, 36, 56, 58, 68, 92 of the projections 10, 12, 14, 16 each comprise a radially extending section 42, 64, 76, 98 the load applied by the projections on the buffer elements of the respective one of the first and second plurality of buffer elements 18, 20 is in the circumferential direction. It will be appreciated that the load applied to the buffer elements of the first and second plurality of buffer elements 18, 20 may include a radial component, but the resultant load applied to the buffer elements is generally in the circumferential direction. Advantageously, this results in the stress that the buffer elements of the first and second plurality of buffer elements 18, 20 being a substantially compressive stress. This is in contrast to known couplings that apply a load that includes both a circumferential and radial component, which results in the buffer members of the known coupling experiencing shear stress. Therefore, by subjecting the buffer elements of the first and second plurality of buffer elements 18, 20 to a generally compressive stress, the torque transfer capacity of the coupling 2 is increased compared to a coupling that subjects the buffer elements to a shear stress.

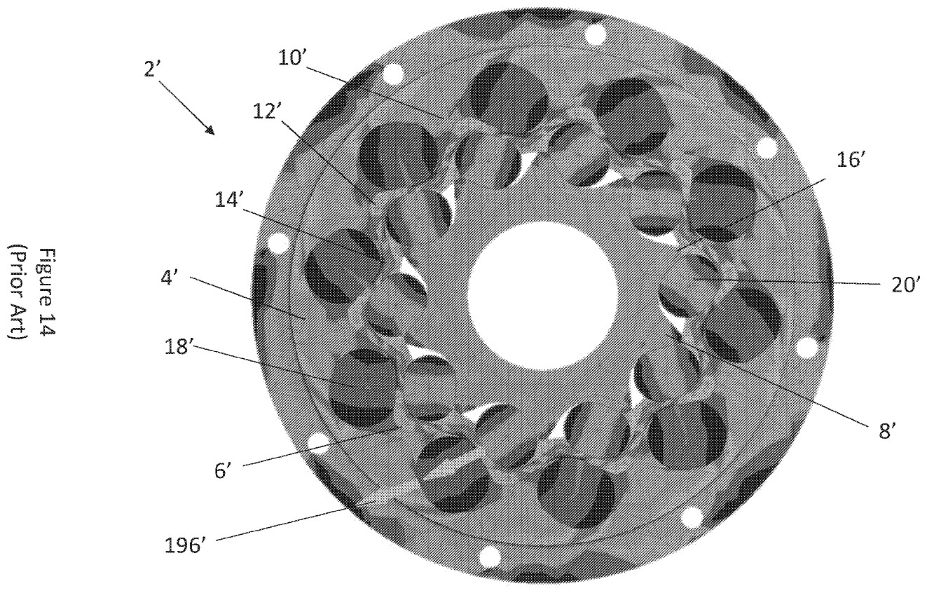

Referring now to FIG. 14, a stress distribution obtained using finite element analysis for a known coupling 2′ is shown. As can be seen, the known coupling 2′ the projections 10′, 12′, 14′, 16′ of the members 4′, 6′, 8′ extend both circumferentially and radially. Therefore, the direction of torque transfer (indicated by arrows 196′) includes a component in the circumferential direction and a component in the radial direction.

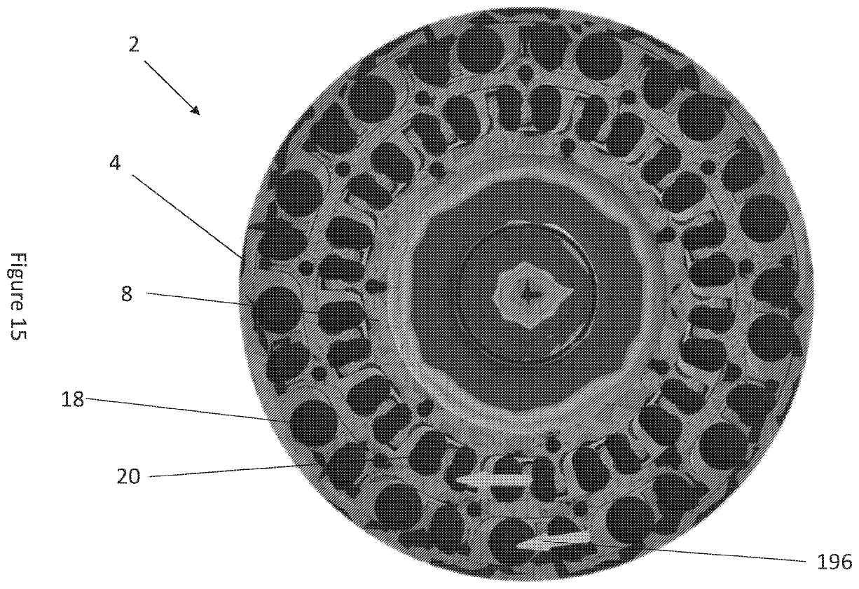

Referring now to FIG. 15, a stress distribution obtained using finite element analysis for the coupling 2 of the present invention is shown. The load applied to the inner and outer members 4, 8 of the coupling 2 in the model used to obtain FIG. 15 is identical to the load applied to the inner and outer members 4′, 8′ of the known coupling of FIG. 14. As can be seen the direction of torque transfer (indicated by arrows 196) is in the circumferential direction. Furthermore, comparing the stress distribution of the buffer elements of the first and second plurality of buffer elements 18, 20 to the buffer elements of the known coupling 2′, the buffer elements 18′, 20′ of the known coupling are subject to greater stress under loading. This is indicated by the lighter colour of the buffer elements of the known coupling.

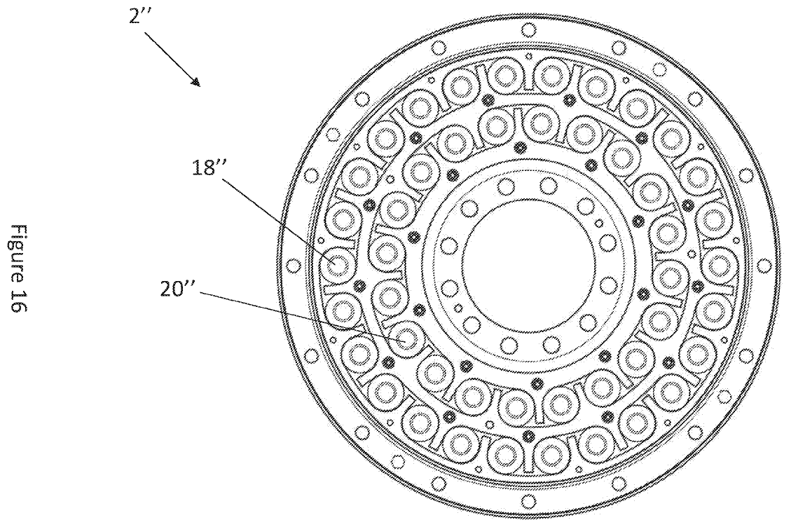

Referring now to FIG. 16, an embodiment of the coupling 2″ is depicted. In this embodiment, the buffer elements of the first plurality of buffer elements 18″ are the same size and shape as the buffer elements of the second plurality of buffer elements 20″. The number of buffer elements of the first plurality of buffer elements 18″ is greater than the number of buffer elements of the second plurality of buffer elements 20″. In this embodiment, the stiffness of the buffer elements of the first plurality of buffer elements 18″ is less than the stiffness of the buffer elements of the second plurality of buffer elements 20″. However, the stiffness of the buffer elements of the first plurality of buffer elements 18″ may be greater than the stiffness of the buffer elements of the second plurality of buffer elements 20″. Alternatively, the stiffness of the buffer elements of the first plurality of buffer elements 18″ may be equal to the stiffness of the buffer elements of the second plurality of buffer elements 20″. Where the stiffness of the buffer elements of the first plurality of buffer elements 18″ is equal to the stiffness of the buffer elements of the second plurality of buffer elements 20″, the buffer elements of each plurality of buffer elements may be substantially identical to one another. The inner and outer buffer elements may be the same, with the difference in stiffness of the respective inner and outer pluralities of buffer elements being different due to the difference in number of elements in the respective inner and outer pluralities of buffer elements.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below. The depicted embodiments of the present invention are in order to assist in the understanding of the invention, which is defined in the appended claims.

1-25. (canceled)

26. A coupling comprising:
an outer member, an inner member, an intermediate member, and a plurality of buffer elements;
wherein the outer member comprises a plurality of radially inward projections, the inner member comprises a plurality of radially outward projections and the intermediate member comprises a plurality of radially inward projections and a plurality of radially outward projections;
wherein the plurality of buffer elements are disposed between the projections; and
wherein the plurality of radially inward projections of the outer member and the plurality of radially outward projections of the intermediate member are radially overlapped, and the plurality of radially outward projections of the inner member and the plurality of radially inner projections of the intermediate member are radially overlapped.

27. The coupling of claim 26, wherein the projections define a first radial surface and a second opposing radial surface, the first radial surface and the second radial surface extending substantially only in the radial direction.

28. The coupling of claim 26, wherein the number of radially outward projections of the intermediate member differs from the number of radially inward projections of the intermediate member.

29. The coupling of claim 26 wherein the number of radially outward projections of the inner member is greater than the number of radially inward projections of the outer member.

30. The coupling of claim 26, wherein the inner member, the intermediate member and the outer member each comprise a first side and a second side, the second side opposing the first side.

31. The coupling of claim 30, wherein the inner member and/or the intermediate member and/or the outer member comprise a plurality of apertures, the apertures extending from the first side to the second side of a respective one of the inner member, the intermediate member and the outer member, and wherein the apertures receive a respective axial buffer of a plurality of axial buffers.

32. The coupling of claim 30, wherein the axial buffers and plurality of apertures are configured such that the axial buffers are insertable and removable from a respective aperture with access to only one of the first side or the second side of the respective one of the inner member, the intermediate member or the outer member.

33. The coupling of claim 31, wherein the axial buffers of the plurality of axial buffers comprise a first end piece and a second end piece.

34. The coupling of claim 33, wherein the axial buffers of the plurality of axial buffers each further comprise a respective body, and wherein the first end piece and the second end piece of each axial buffer are received by a respective body.

35. The coupling of claim 34, wherein the body of the axial buffers is configured to be secured within a respective opening.

36. The coupling of claim 34, wherein at least part of the body is threaded, and wherein the body is threadably engageable with a respective aperture of the inner member, the intermediate member or the outer member.

37. The coupling of claim 26, wherein the plurality of buffer elements comprises a first plurality of buffer elements, the first plurality of buffer elements being located between the plurality of radially inward projections of the outer member and the radially outward projections of the intermediate member.

38. The coupling of claim 26, wherein the plurality of buffer elements comprises a second plurality of buffer elements, the second plurality of buffer elements being located between the radially outward projections of the inner member and the inner projections of the intermediate member.

39. The coupling of claim 37, wherein the first plurality of buffer elements are less stiff than the second plurality of buffer elements.

40. The coupling of claim 37, wherein the thickness of the buffer elements of the second plurality of buffer elements tapers in the radially inward direction and/or are discrorectangular, preferably tapered discorectangular, in cross-section.

41. The coupling of claim 37, wherein the buffer elements of the first plurality of buffer elements are substantially circular in radial cross-section.

42. The coupling of claim 37, wherein the first plurality of buffer elements fills a lower proportion of the space in which they are disposed than the second plurality of buffer elements.

43. The coupling of claim 37, wherein the size and/or shape and/or hardness of the buffer elements of the first plurality of buffer elements is substantially identical to the size and/or shape and/or hardness of the buffer elements of the second plurality of buffer elements.

44. The coupling of any of claim 37, wherein the hardness of the second plurality of buffer elements is greater than the first plurality of buffer elements.

45. The coupling of any of claim 37, wherein the cross sectional area of each of the first plurality of buffer elements is greater than the cross sectional area of each of the second plurality of buffer elements.

46. The coupling of claim 26, wherein the number of buffer elements of the second plurality of buffer elements is greater than the number of buffer elements of the first plurality of buffer elements; or wherein
the number of buffer elements of the second plurality of buffer elements is less than the number of buffer elements of the first plurality of buffer elements.

47. The coupling of claim 26, wherein the buffer elements of the first plurality of buffer elements are circular in cross-section and the buffer elements of the second plurality of buffer elements are tapered discorectangular in cross section.

48. An assembly comprising:
a coupling having:
an outer member, an inner member, an intermediate member, and a plurality of buffer elements;
wherein the outer member comprises a plurality of radially inward projections, the inner member comprises a plurality of radially outward projections and the intermediate member comprises a plurality of radially inward projections and a plurality of radially outward projections;
wherein the plurality of buffer elements are disposed between the projections; and
wherein the plurality of radially inward projections of the outer member and the plurality of radially outward projections of the intermediate member are radially overlapped, and the plurality of radially outward projections of the inner member and the plurality of radially inner projections of the intermediate member are radially overlapped;
a first shaft and a second shaft; and
wherein the first shaft is coupled to the inner member and the second shaft is coupled to the outer member.

49. A marine vessel comprising the coupling as defined in claim 26.

50. A generator comprising the coupling as defined in claim 26, wherein the generator is a diesel generator.
